(19) United States
(12) Patent Application Publication
(10) Pub. No.: US 2016/0335225 A1
(43) Pub. Date: Nov. 17, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Taro YOSHIHAMA, Kanagawa (JP)

(73) Assignee: FUJI XEROX CO., LTD., Tokyo (JP)

(21) Appl. No.: 14/937,232

(22) Filed: Nov. 10, 2015

(30) Foreign Application Priority Data
May 15, 2015 (JP) 2015-099762

(51) Int. Cl. G06F 17/21; G06F 3/14; G06F 3/041

(52) U.S. Cl. CPC G06F 17/211; G06F 3/041; G06F 3/14

(57) ABSTRACT

An information processing apparatus includes a storage unit, a starting unit, and a display unit. The storage unit stores a first program that is independently startable, and a second program that is started to implement a particular function of the first program. The starting unit starts the second program corresponding to the particular function of the first program when the particular function is implemented. The display control unit performs control so as to display message information corresponding to a version of the second program on a display section after the first program stored in the storage unit is started and before the second program is stated.

### CROSS-REFERENCE TO RELATED APPLICATIONS

This application is based on and claims priority under 35 USC 119 from Japanese Patent Application No. 2015-099762 filed May 15, 2015.

### BACKGROUND

(i) Technical Field

The present invention relates to an information processing apparatus, an information processing method, and a non-transitory computer readable medium.

(ii) Related Art

A program that operates on basic software called an operating system (OS) is called an application program (application software).

The application programs (hereinafter abbreviated as “applications”) include a main application (first application) that is independently startable, and a sub application (second application) that is started to implement a particular function of the main application.

Some sub applications are not independently startable and are operable only on the main application, while others are independently startable but are operable in conjunction with the main application to function effectively.

If only the main application is started in the case where it is attempted to display a message about the application that is about to be started, message information about the main application may be displayed, but message information about a sub application is not displayed. Message information about the sub application is displayed each time the sub application is started.

### SUMMARY

According to an aspect of the present invention, there is provided an information processing apparatus including a storage unit that stores a first program that is independently startable, and a second program that is started to implement a particular function of the first program, a starting unit that starts the second program corresponding to the particular function of the first program when the particular function is implemented, and a display control unit that performs control so as to display message information corresponding to a version of the second program on a display section after the first program stored in the storage unit is started and before the second program is stated.

### BRIEF DESCRIPTION OF THE DRAWINGS

An exemplary embodiment of the present invention will be described in detail based on the following figures, wherein:

FIG. 1 is a system diagram illustrating an information processing system according to an exemplary embodiment of the present invention;

FIG. 2 is a block diagram illustrating the hardware configuration of an information processing apparatus 10 according to the exemplary embodiment of the present invention;

FIG. 3 is a block diagram illustrating the functional configuration of the information processing apparatus 10 according to the exemplary embodiment of the present invention;

FIG. 4 is a schematic diagram illustrating the relationship between a main application and sub applications;

FIG. 5 illustrates an example of an application relationship table that indicates the relationship between main applications and sub applications;

FIG. 6 illustrates an example of an information file in which message information to be displayed is set for each version of the main application and the sub application;

FIG. 7 illustrates an example of an information file in which storage location information on a storage location where message information to be displayed is stored is indicated in place of the message information;

FIG. 8 illustrates an example of an information file in which storage location information on a storage location where message information to be displayed is stored is indicated in place of the message information;

FIG. 9 is a flowchart illustrating operation of the information processing apparatus 10 according to the exemplary embodiment of the present invention;

FIG. 10 illustrates an example of message information to be displayed in the information processing apparatus 10 according to the exemplary embodiment of the present invention;

FIG. 11 illustrates an example of message information to be displayed in the information processing apparatus 10 according to the exemplary embodiment of the present invention;

FIG. 12 illustrates an example of an information file that is capable of forcibly stopping utilization of a particular application; and

FIG. 13 illustrates an example in which an application relationship table is included in an information file.

### DETAILED DESCRIPTION

Now, an exemplary embodiment of the present invention will be described in detail below with reference to the drawings.

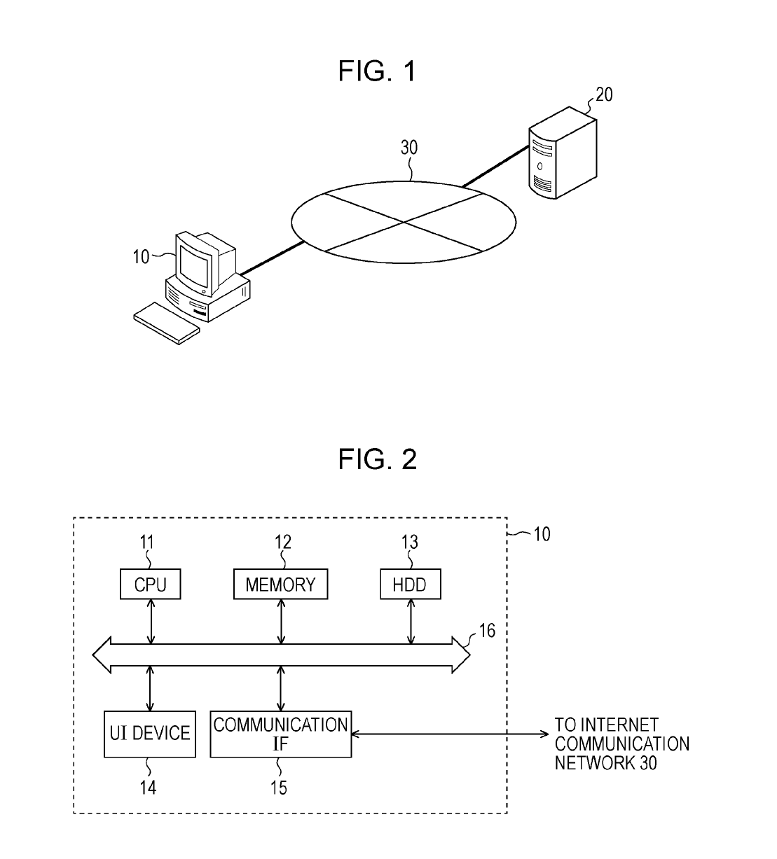

FIG. 1 is a system diagram illustrating an information processing system according to an exemplary embodiment of the present invention.

As illustrated in FIG. 1, the information processing system according to the exemplary embodiment of the present invention is composed of an information processing apparatus 10 and a web server device 20 connected to each other through an Internet communication network 30. For simplicity of the description, a single information processing apparatus 10 is provided. However, plural information processing apparatuses 10 may be connected to the web server device 20 via the Internet communication network 30.

The web server device 20 is a server device that provides a web service via the Internet communication network 30.

The information processing apparatus 10 is connected to the web server device 20 via the Internet communication network 30 to utilize the web service provided by the web server device 20.

In the exemplary embodiment, the information processing apparatus 10 is connected to the web server device 20 via the Internet communication network 30 to utilize a web service for downloading an information file to acquire the information file. The information file will be discussed in detail later.

Next, the hardware configuration of the information processing apparatus 10 in the information processing system according to the exemplary embodiment is illustrated in FIG. 2.

As illustrated in FIG. 2, the information processing apparatus 10 includes a central processing unit (CPU) 11, a memory 12, a storage device 13 such as a hard disk drive (HDD), a user interface (UI) device 14 that includes a touch panel or a liquid crystal display and a keyboard, and a communication interface (IF) 15 that transmits and receives data to and from an external device such as the web server device 20 via the Internet communication network 30. Such components are connected to each other via a control bus 16.

The CPU 11 controls operation of the information processing apparatus 10 by executing a predetermined process on the basis of a control program stored in the memory 12 or the storage device 13. In the exemplary embodiment, the CPU 11 reads and executes a control program stored in the memory 12 or the storage device 13. However, such a program may be stored in a storage medium such as a CD-ROM to be provided to the CPU 11.

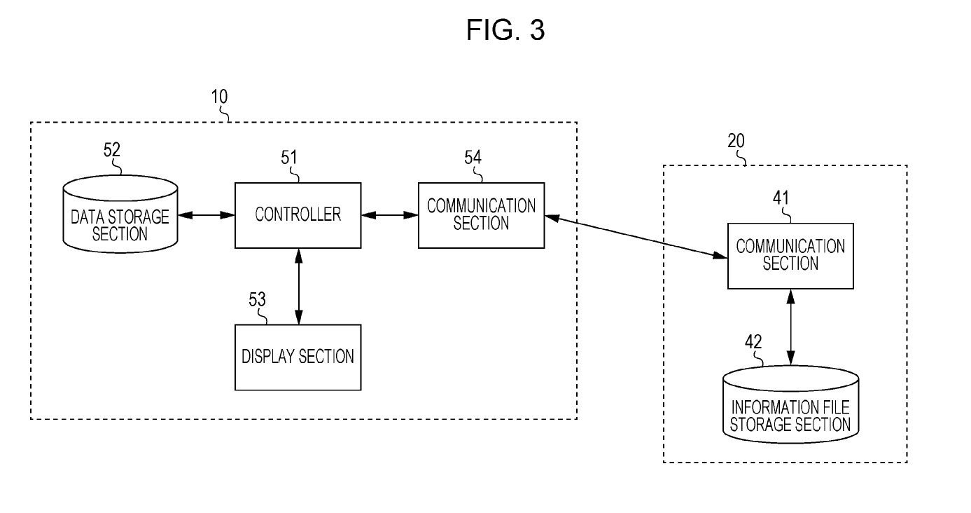

FIG. 3 is a block diagram illustrating the functional configuration of the information processing apparatus 10 implemented by executing the control program described above.

As illustrated in FIG. 3, the information processing apparatus 10 according to the exemplary embodiment includes a controller 51, a data storage section 52, a display section 53, and a communication section 54. In addition, the web server device 20 includes a communication section 41 and an information file storage section 42.

The data storage section 52 stores a main application program (first program) that is independently startable, and a sub application program (second application) that is started to implement a particular function of the main application program.

The main application program (hereinafter abbreviated as a “main application”) is an application program that is independently startable such as document preparation software and Internet browser software, for example, that is provided with an interface function that enables cooperation with other application programs, and that is functionally expandable in conjunction with other applications.

The sub application program (hereinafter abbreviated as a “sub application”) is a program that is started to implement a particular function of the main application such as an application program for implementing a format changing function that operates on document preparation software, for example.

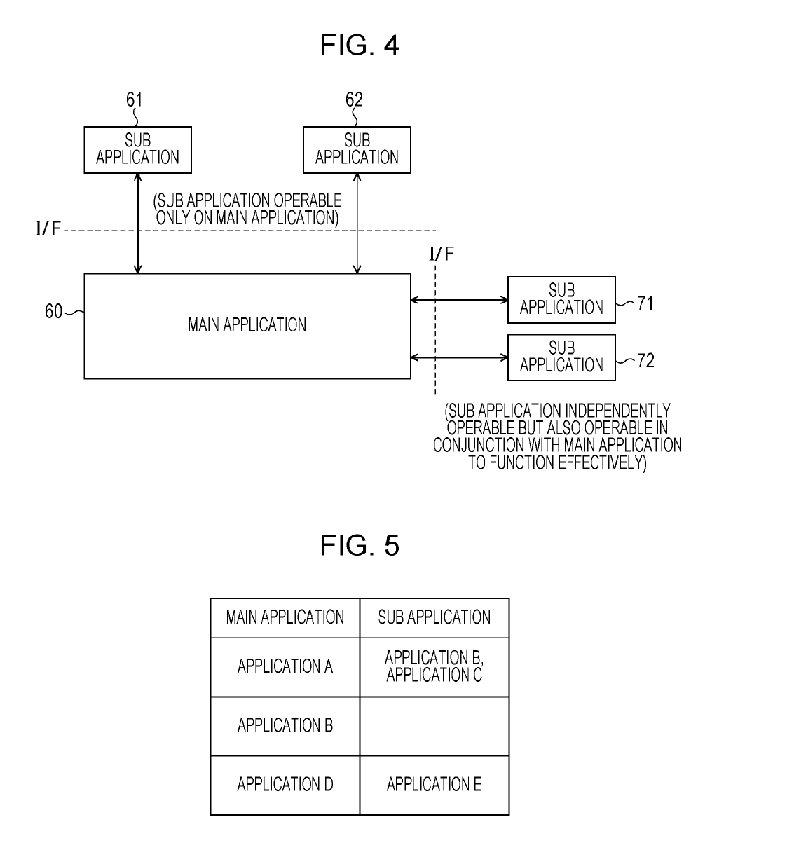

The relationship between a main application and sub applications will be described with reference to the schematic diagram of FIG. 4.

As illustrated in FIG. 4, sub applications 61 and 62 are each a program that is operable only on a main application 60, and is not startable when the main application 60 is not started. On the contrary, sub applications 71 and 72 are each a program that is independently startable to be operable, but that is also operable in conjunction with the main application 60 to function effectively.

The sub applications 61, 62, 71, and 72 are all programs that are started to implement a particular function of the main application 60.

The sub applications to which the exemplary embodiment is applicable are installed in the information processing apparatus 10 using an installer that is separate from an installer that is used to install the main application. That is, the exemplary embodiment is applicable to sub applications, the version of each of which may not be specified from the version of the main application. Such sub applications may be updated regardless of the state, such as the version, of the main application.

The data storage section 52 also stores an application relationship table (dependence relationship information) that indicates the relationship between main applications and sub applications.

An example of the application relationship table is illustrated in FIG. 5. In the application relationship table illustrated in FIG. 5, an application A, which serves as a main application, has applications B and C as sub applications, and an application D, which serves as a main application, has an application E as a sub application. In addition to being a sub application for the application A, the application B is also independently startable to function as a main application. Therefore, the application B is also indicated as a main application in the application relationship table illustrated in FIG. 5. That is, a certain application may be both a main application and a sub application.

An application relationship table such as that illustrated in FIG. 5 is specifically stored in a registry, a configuration file, or the like of the information processing apparatus 10.

The display section 53 displays various types of information, such as message information, to a user on the basis of control by the controller 51.

The communication section 54 accesses the web server device 20 via the Internet communication network 30 to acquire an information file.

When a particular function of the main application is executed, the controller 51 starts a sub application corresponding to the executed function of the main application, among the plural sub applications stored in the data storage section 52.

When the main application stored in the data storage section 52 is started, the controller 51 determines whether or not a sub application that is started to implement a particular function of the main application to be started is present in the data storage section 52. In the case where it is determined that the sub application that is started to implement a particular function of the main application to be started is present in the data storage section 52, the controller 51 acquires message information corresponding to the current version of the main application and message information corresponding to the current version of the sub application, and performs control so as to display such message information on the display section 53 after the main application is started and before the sub application is started.

When the main application stored in the data storage section 52 is started, the controller 51 also acquires, from the web server device 20 which is an external device, an information file in which message information to be displayed is set for each version of the main application and the sub application.

In the web server device 20, the information file described above is stored in the information file storage section 42. In the web server device 20, when a request from the information processing apparatus 10 is received via the communication section 41, the information file stored in the information file storage section 42 is transmitted to the information processing apparatus 10 via the communication section 41.

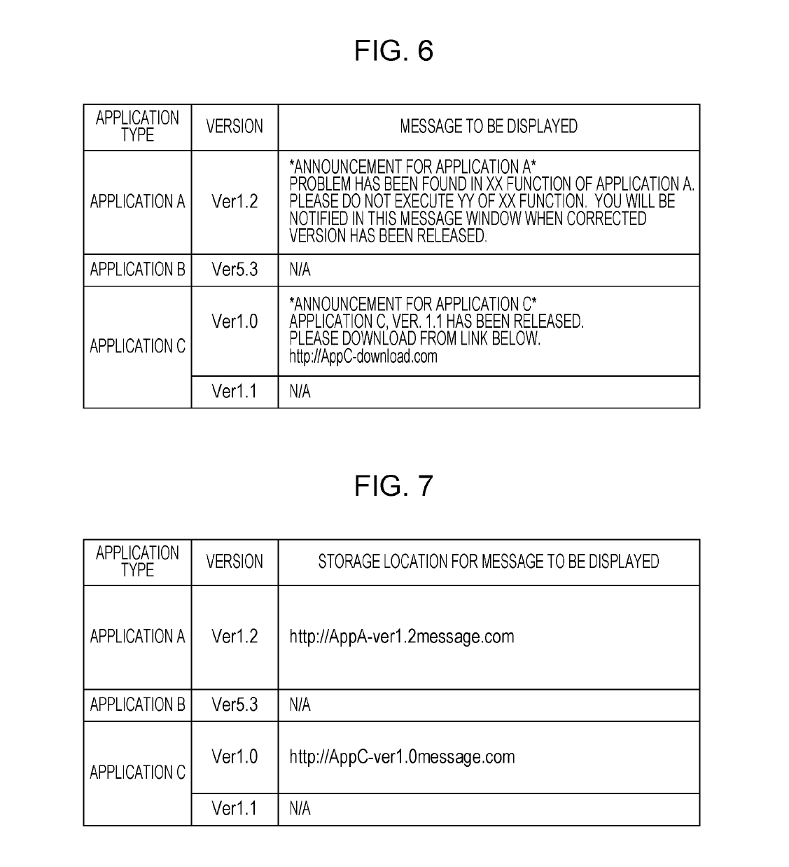

An example of the information file will be described with reference to FIG. 6. For example, the information file illustrated in FIG. 6 indicates that the following message should be displayed for the application A, Ver. 1.2: “A problem has been found in the xx function of the application A. Please do not execute yy of the xx function. You will be notified in this message window when a corrected version has been released.”

In addition, the information file illustrated in FIG. 6 indicates that the message information to be displayed for the application C, Ver. 1.0 includes storage location information on a storage location for an update program for updating the application C (to Ver. 1.1).

In this way, the message information to be displayed may include storage location information on a storage location for an update program for updating a main application or a sub application.

Then, the controller 51 specifies, from an application relationship table such as that illustrated in FIG. 5, a sub application that is started to implement a particular function of the main application to be started, that is, a sub application associated with the main application to be started.

Then, the controller 51 specifies message information to be displayed on the basis of version information on the main application to be started, version information on the sub application to be started to implement a particular function of the main application, and the acquired information file, and performs control so as to display the specified message information on the display section 53.

In the information processing apparatus 10, the entire information file in which message information is set for each version of the main application and the sub application may be acquired from the web server device 20 to extract message information corresponding to the current versions of the main application and the sub application. In this case, it is not necessary to notify the web server device 20 of the current versions of the applications used.

Alternatively, message information for the versions of the main application and the sub application may be acquired from the web server device 20. In this case, it is possible for the web server device 20 to count the number of times of acquisition of message information for each version, which makes it possible to grasp the number of times of acquisition of message information for what application of what version.

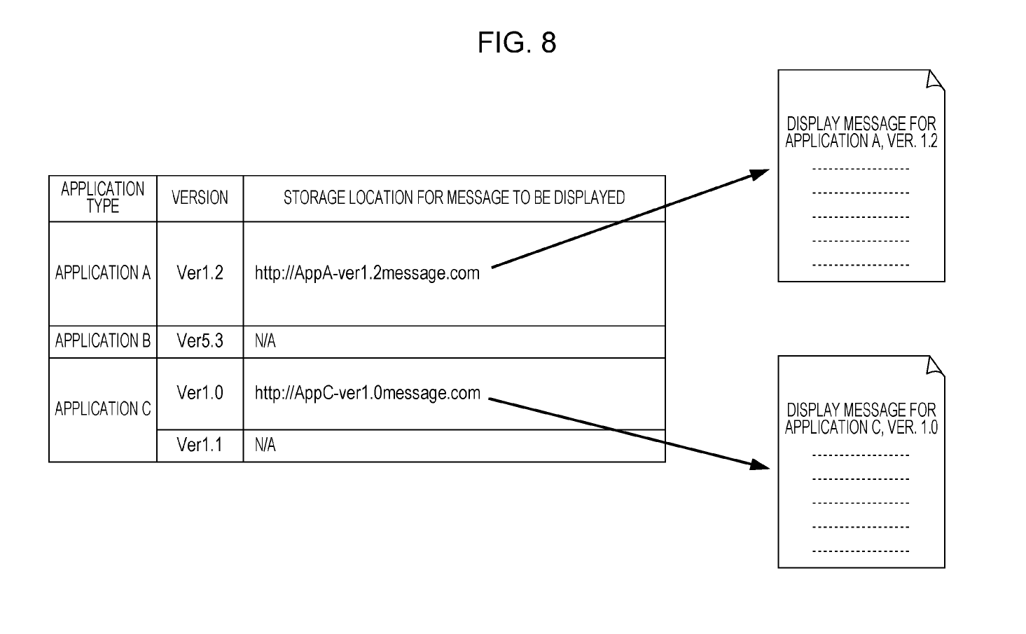

In the example of the information file illustrated in FIG. 6, message information to be displayed itself is indicated for each version of the applications. As in the example of the information file illustrated in FIGS. 7 and 8, however, link information, such as a uniform resource locator (URL), that indicates a location where message information to be displayed is stored may be indicated as storage location information in place of the message information.

In this case, after the web server device 20 acquires the information file to specify the versions of the main application and the sub application, the information processing apparatus 10 acquires message information corresponding to the versions of the applications from the storage location indicated in the storage location information.

That is, the controller 51 acquires, from the web server device 20, an information file, in which storage location information on a storage location for message information to be displayed is set for each version of the main application and the sub application, when the main application is started, and acquires message information to be displayed on the basis of the version of the main application to be started, the version of the sub application associated with the main application, and the acquired information file. Then, the controller 51 performs control so as to display the acquired message information on the display section 53.

If message information is not included in an information file but stored at a separate storage location, it is possible for the web server device 20 to count the number of times of acquisition of message information, which makes it possible to grasp the number of times of acquisition of message information for what application of what version. As a result, for example, it is possible to grasp the number of users, among the users who utilize a certain application of a particular version, that are notified of the message.

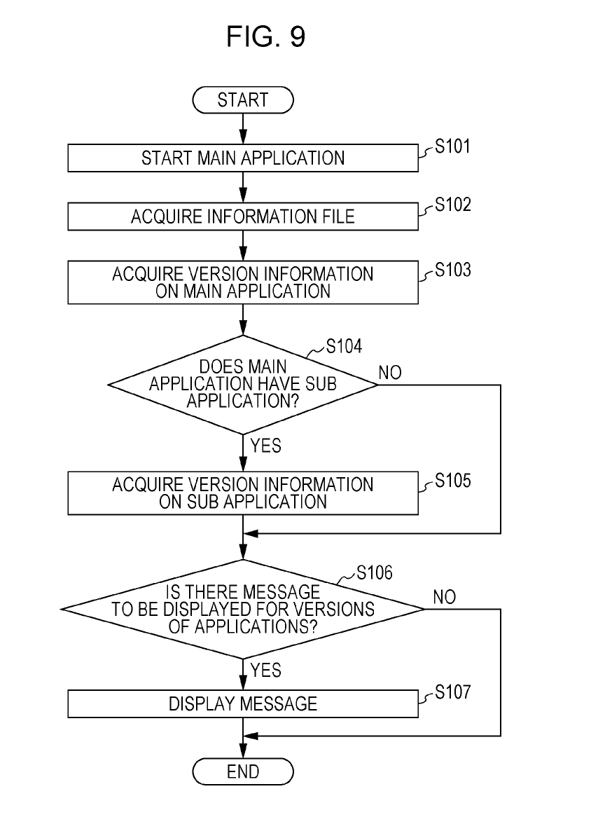

Next, operation of the information processing apparatus 10 according to the exemplary embodiment will be described in detail below with reference to the flowchart of FIG. 9.

In the following description, an application relationship table such as that illustrated in FIG. 5 is stored in the information processing apparatus 10, and an information file such as that illustrated in FIG. 6 is stored in the web server device 20. In addition, the application A is started as the main application.

First, when the main application A is started in the information processing apparatus 10 (step S101), the controller 51 of the information processing apparatus 10 accesses the web server device 20 via the communication section 54 to acquire an information file such as that illustrated in FIG. 6 (step S102).

Then, the controller 51 acquires version information on the application A which is the main application (step S103). In addition, the controller 51 references the application relationship table illustrated in FIG. 5 to determine whether or not the main application A which has been started has a sub application (step S104). In this example, the main application A has sub applications B and C as sub applications for the main application A (yes in step S104), and therefore the controller 51 acquires version information on the sub applications B and C (step S105).

Then, the controller 51 references the information file acquired in step S102 to determine whether or not there is message information to be displayed for each of the versions of the main application A and the sub applications B and C (step S106).

In the case where there is message information to be displayed for each of the versions of the main application A and the sub applications B and C (yes in step S106), the controller 51 displays message information indicated in the information file on the display section 53 (step S107).

In the case where there is not message information to be displayed for any of the versions of the main application A and the sub applications B and C (no in step S106), the controller 51 ends the process without displaying message information.

In the flowchart described above, the entire information file is acquired from the web server device 20 to extract message information corresponding to the current versions of the main application and the sub applications. However, after specifying the current versions of the main application and the sub applications, message information corresponding to the specified versions of the applications may be acquired from the web server device 20.

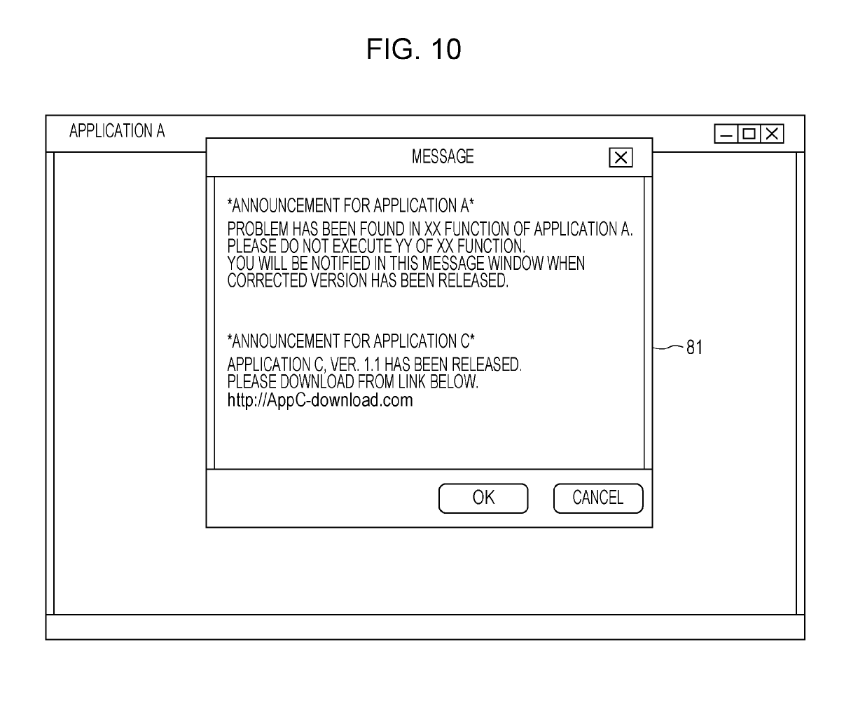

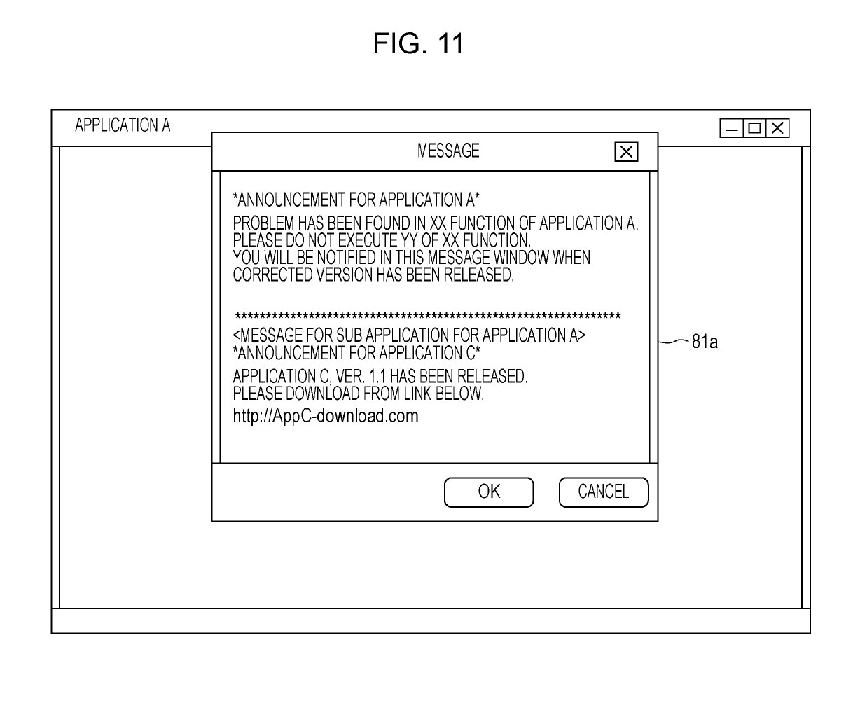

Examples of message information to be displayed in this way are illustrated in FIGS. 10 and 11.

In the following examples, the version of the main application A installed in the information processing apparatus is Ver. 1.2, the version of the sub application B is Ver. 5.3, and the version of the sub application C is Ver. 1.0. In this case, there is message information to be displayed for the main application A and the sub application C, but there is no message information to be displayed for the sub application B.

In the display example of message information illustrated in FIG. 10, message information on the main application A and message information on the sub application C are collectively displayed within an identical display window 81.

Therefore, message information on the sub application C is displayed to the user together with message information on the main application A just by starting the application A, which is the main application, even though the sub application C is not started.

Alternatively, the controller 51 may display message information corresponding to the version of the sub application on the display section 53 while expressly indicating that the message information is about the sub application. A display example of message information to be displayed in such a case is illustrated in FIG. 11.

Also in the display example of message information illustrated in FIG. 11, message information on the main application A and message information on the sub application C are collectively displayed within an identical display window 81a. In the display example of message information illustrated in FIG. 11, further, a text “<Message for sub application for application A>” is displayed together with message information on the sub application C to expressly indicate that the application C is a sub application for the application A.

In the exemplary embodiment described above, in the case where there is a problem with the main application or the sub application and it is desirable that the user should refrain from using the application, the user is notified not to use the application through the message information.

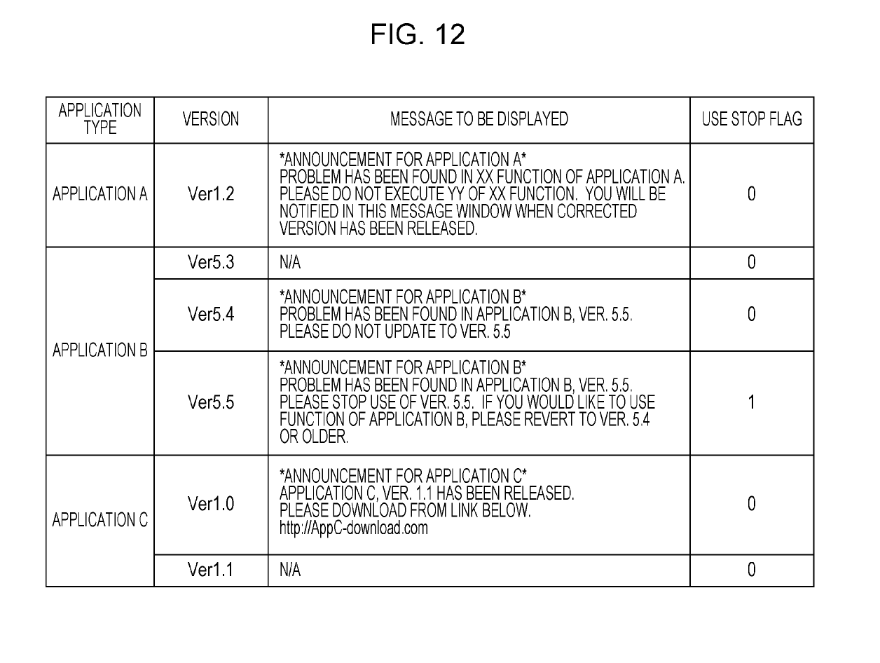

However, by using an information file configured as illustrated in FIG. 12, for example, utilization of a particular application may be forcibly stopped.

In the example of the information file illustrated in FIG. 12, a serious problem has been found with the application B, Ver. 5.5, and it is desirable to prohibit utilization of the application B, Ver. 5.5 by the user. The information file includes a use stop flag (emergency stop information) that indicates that use of each version of the main application and the sub applications should be stopped.

In the information file illustrated in FIG. 12, the use stop flag corresponding to the application B, Ver. 5.5 is set to “1”, and it is indicated that use of the application B, Ver. 5.5 should be stopped.

In the case where such an information file is acquired from the web server device 20 and the application B, Ver. 5.5 has been started as a main application, or in the case where a main application that has the application B, Ver. 5.5 as a sub application has been started, the controller 51 enables emergency stop without starting the application B, Ver. 5.5, and notifies the user.

In the exemplary embodiment described above, further, an application relationship table that indicates the relationship between main applications and sub applications is stored in the information processing apparatus 10. However, the application relationship table may be included in the information file stored in the web server device 20.

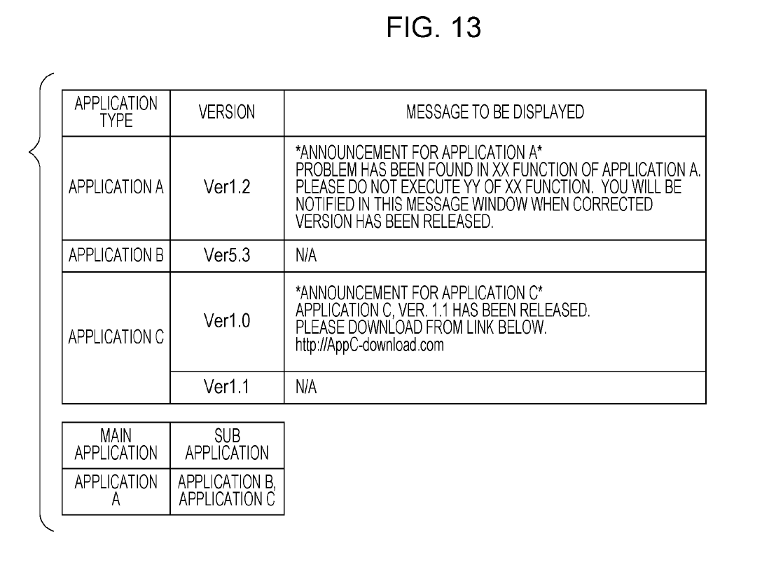

An example in which the application relationship table is included in the information file is illustrated in FIG. 13. The information file illustrated in FIG. 13 not only indicates message information to be displayed for each version of the applications, but also includes information indicating that the application A has the applications B and C as sub applications.

In the exemplary embodiment described herein, the programs are provided through a communication unit. However, the programs may also be provided as stored in a storage medium such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage unit that stores a first program that is independently startable, and a second program that is started to implement a particular function of the first program;
a starting unit that starts the second program corresponding to the particular function of the first program when the particular function is implemented; and
a display control unit that performs control so as to display message information corresponding to a version of the second program on a display section after the first program stored in the storage unit is started and before the second program is stated.

2. The information processing apparatus according to claim 1,
wherein a plurality of such second programs are provided, and
the display control unit performs control so as to display message information corresponding to versions of the plurality of second programs on the display section together with message information corresponding to a version of the first program.

3. The information processing apparatus according to claim 1, further comprising:
an acquisition unit that acquires, from an external device, an information file, in which message information to be displayed is set for each version of the second program, when the first program stored in the storage unit is started,
wherein the display control unit specifies message information to be displayed on the basis of the version of the second program and the information file acquired by the acquisition unit, and performs control so as to display the specified message information on the display section.

4. The information processing apparatus according to claim 1, further comprising:
an acquisition unit that acquires, from an external device, message information to be displayed corresponding to the version of the second program when the first program stored in the storage unit is started; and
a counting unit that counts a number of times of acquisition of the message information for each version.

5. The information processing apparatus according to claim 1, further comprising:
an acquisition unit that acquires, from an external device, an information file, in which storage location information on a storage location for message information to be displayed is set for each version of the second program, when the first program stored in the storage unit is started, and that acquires message information to be displayed on the basis of the version of the second program and the acquired information file; and
a counting unit that counts a number of times of acquisition of the message information for each version,
wherein the display control unit performs control so as to display the message information acquired by the acquisition unit on the display section.

6. The information processing apparatus according to claim 1,
wherein the message information includes storage location information on a storage location for an update program for updating the second program.

7. The information processing apparatus according to claim 1,
wherein the display control unit performs control so as to display message information corresponding to the version of the second program on the display section while expressly indicating that the message information is about the second program.

8. The information processing apparatus according to claim 1,
wherein the storage unit stores dependence relationship information that indicates a relationship between the first program and the second program.

9. The information processing apparatus according to claim 1,
wherein the information file includes dependence relationship information that indicates a relationship between the first program and the second program.

10. The information processing apparatus according to claim 1,
wherein the information file includes emergency stop information that indicates that use of each version of the second program should be stopped.

11. An information processing method comprising:
storing a first program that is independently startable, and a second program that is started to implement a particular function of the first program;
starting the second program corresponding to the particular function of the first program when the particular function is implemented; and
performing control so as to display message information corresponding to a version of the second program on a display section after the first program is started and before the second program is started.

12. A non-transitory computer readable medium storing a program causing a computer to execute a process comprising:
starting a first program that is independently startable; and
performing control so as to display message information corresponding to a version of a second program on a display section after the first program is started and before the second program is started, the second program being started to implement a particular function of the first program.
